(19) United States
(12) Patent Application Publication
(10) Pub. No.: US 2006/0032389 A1
(43) Pub. Date: Feb. 16, 2006

(54) Cleaning of rollers in printing presses

(76) Inventor: Lutz Telljohann, Lengerich (DE)

Correspondence Address: JACOBSON HOLMAN PLLC, 400 SEVENTH STREET N.W., SUITE 600, WASHINGTON, DC, 20004, US

(21) Appl. No.: 10/529,553

(22) PCT Filed: Oct. 14, 2003
(86) PCT No.: PCT/EP03/11356

§ 371 Date: Mar. 29, 2005

(30) Foreign Application Priority Data
Nov. 6, 2002 (DE) 102 52 013.5

(51) Int. Cl. B41F 35/00

(52) U.S. Cl. 101/425

(57) ABSTRACT

The invention concerns a process for the cleaning of components of rollers that are involved in the printing process. The cleaning process involves supplying solvents to these rollers that remain in the printing machine while being cleaned. The cleaning of components of the rollers that are involved in the printing process takes place by a process in which first the printing ink is removed from the blade chamber and the blade chamber is filled with solvent. During the cleaning an active connection is maintained between the blade chamber and the uncleaned components of the rollers that are involved in the printing process. This active connection does not interfere with the transfer of the solvent. The rollers rotate during the cleaning process so that solvent is transferred from the blade chamber onto the uncleaned components of the rollers that are involved in the printing process. When the solvent arrives on the roller components the printing ink is diluted there and/or dried printing ink is dissolved and are transported back into the blade chamber by the rotation of the rollers.

The invention concerns a process for cleaning the components of rollers that are involved in the printing process. The cleaning process involves supplying solvents to these rollers that remain in the printing machine while being cleaned.

The printing of a printing substrate in a flexographic printing machine takes place by a process in which the printing substrate is led on a cylinder and a first roller that is provided with printing plates and that applies the printing ink carried by the printing plate on the printing substrate. The printing ink required for this is taken out by one or several rollers from a blade chamber that serves as an ink reservoir and transferred onto the printing plates of the print roller.

In accordance with a printing process of such type it is necessary to clean the components of the different rollers e.g. the printing plates provided on a print roller. The cleaning process is important to prevent the drying and adhesion of the remaining printing ink. The process for removing firmly adhesive printing ink involves considerable expenditure. The mechanical effects during the cleaning of the components of rollers with adhesive printing ink frequently leads to damages of the components of the rollers.

The patent specification EP 0 742 756 B1 states a process for cleaning of printing plates. In this process small sub areas of the components of the rollers are cleaned one after another. A device for the implementation of the cleaning process contains a nozzle that contains a mixing chamber in which a fluid is prepared by mixing pressurized air and a solvent. The nozzle sprays the fluid in the direction of the printing roller whereby dust, fibers and other particles are detached from the printing plate. Additionally the device contains a suction pipe that sucks off the fluid and also dust, fibers and other particles from the printing plate.

One problem of the device required for the implementation of said cleaning process is the required space inside the printing machine. In a flexographic printing machine that e.g. prints with 8 different inks simultaneously, the printing rollers are narrowly adjacent such that there is no sufficient space for a device of such kind.

Therefore, the task underlying the present invention is to suggest a process for the cleaning of the printing plates that requires no additional device to be integrated into the inking unit.

This task is solved by a process for the cleaning of printing plates whereby first the printing ink is removed from the blade chamber and the blade chamber is filled with solvent. During the cleaning an active connection (mechanical linkage) is maintained between the blade chamber and the roller components that are involved in the printing process and require cleaning. This active connection does not interfere with the transfer of the solvent. The rollers rotate during the cleaning process so that the solvent is transferred from the blade chamber onto the uncleaned components of the rollers that are involved in the printing process. When the solvent reaches the roller components, printing ink is diluted and/or dried printing ink is dissolved. This dissolved printing ink is then transported back to the blade chamber by the rotation of the rollers.

The particular advantage of this process is that for the cleaning of the components of the rollers that are involved in the printing process, only those components of an inking unit are used that are also necessary for the printing operation. As opposed to the printing operation in which the roller that is in contact with the blade chamber is supplied with printing ink, which the roller delivers to another roller, in the cleaning operation the roller that is in contact with the blade chamber collects printing ink from the other roller. The printing ink is then washed off by the solvent in the blade chamber by the roller that is in contact with the blade chamber.

It is preferable to first clean the roller that is in direct connection with the blade chamber while no other roller is in contact with this roller (the roller that is in direct contact with the blade chamber). After cleaning one roller, the next adjacent roller is again brought into connection with the previously cleaned roller, whereby again the contact to the next adjoining and not yet cleaned roller is interrupted. In this manner the components of all the rollers that are involved in the printing process can be cleaned successively and effectively.

It is advantageous if the solvent is circulated inside the blade chamber. This can happen in a closed circulation in which only one pump is connected between discharge and feed lines. In a preferential design form however one part of the solvent is continuously sucked off via the discharge line from the blade chamber and led into e.g. a dirt tank. The quantity taken out is replaced by non-polluted solvent that is supplied to the blade chamber via the feed lines.

It is useful if the roller that is in direct connection with the blade chamber is kept in constant rotation so that its individual surface areas are periodically brought into contact with the solvent in order to completely wash off the printing ink from the roller.

It is particularly advantageous if all the rollers that are in connection with one another rotate with the same circumferential speeds in order to avoid material wear of the components of the rollers.

In order to ensure that the printing ink from one roller is completely collected by another roller, the rollers that are in connection with each other are arranged closer to one another compared to their arrangement during the printing operation.

Since in case of a closer arrangement of the rollers the individual points on the printing plates can be exposed to a milling movement, there exists the risk that the areas around the points of the printing plates are not cleaned completely. For a thorough cleaning it is useful to reverse the rotational direction of the rollers at least once.

For the automatic implementation of the described process a preferential design form of the invention provides the printing machine with control equipment that also allows manual intervention during the cleaning operation if necessary.

The invention is described more elaborately on the basis of the figures. The individual figures illustrate:

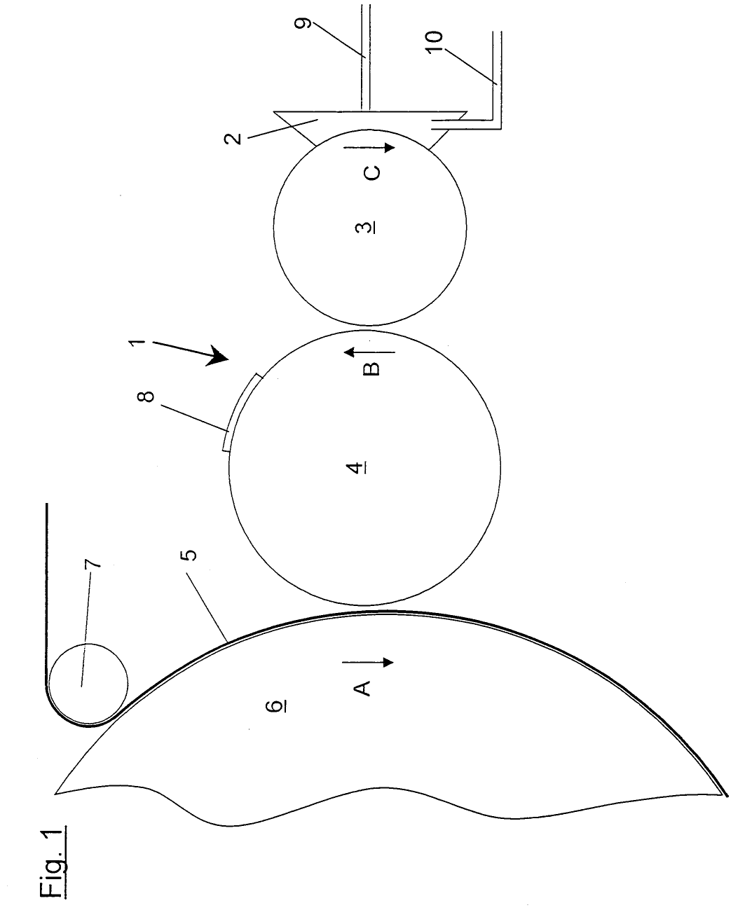

FIG. 1 Inking unit of a flexographic printing machine in the printing operation.

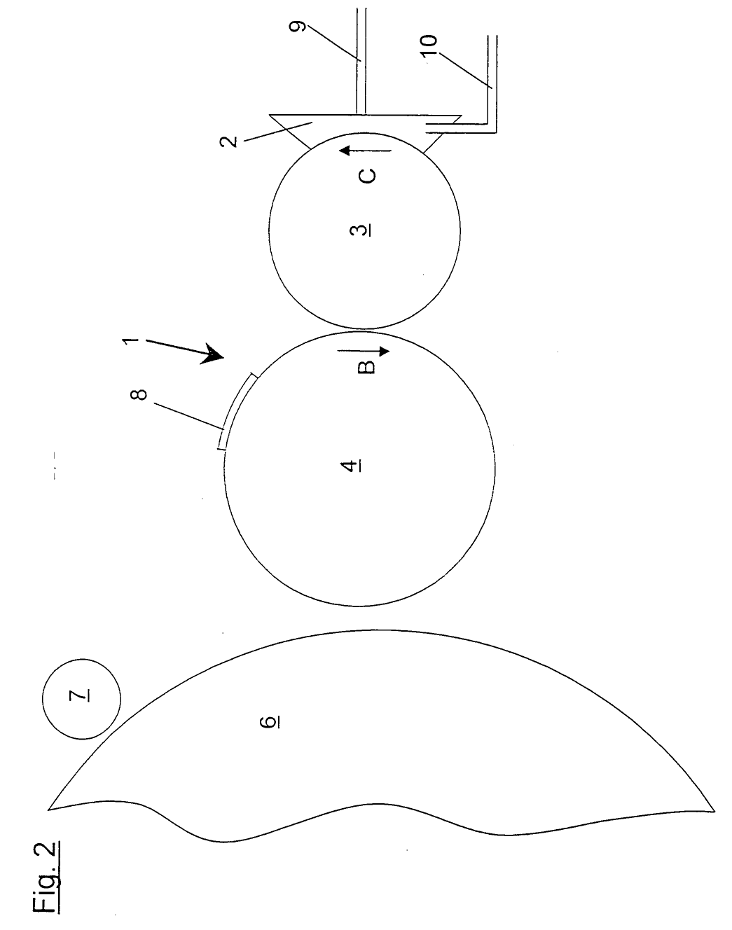

FIG. 2 Inking unit of a flexographic printing machine in the cleaning operation.

In the printing operation of an inking unit 1 in a central cylinder-printing machine in accordance with FIG. 1 the printing ink arrives in the desired format on the printing substrate, in that it is first supplied via the feed line 9 from an ink kit to the blade chamber 2. The anilox roller 3 that rotates in the direction of the arrow C takes over one part of the printing ink. For this purpose the surface of the anilox roller has small depressions (not illustrated) the so-called saucers into which the printing ink arrives. The saucers that come into contact with the printing plate 8 release their printing ink there. The printing plate 8 is applied on the printing roller 4 and is moved by a rotation of the printing roller 4 in the direction of the arrow B to the printing substrate 5. There the printing plate 8 dispenses the printing ink that is clinging to it onto the printing substrate 5. For the purpose of the complete ink transfer the printing substrate 5 that is fed via a deflecting roller 7 runs over the impression cylinder 6 that rotates in the direction of the arrow A.

FIG. 2 illustrates the same inking unit 1 in the cleaning operation. For the cleaning of the printing plate 8 the printing roller 4 can be pressed down (as displayed) by the impression cylinder 6. The rotational directions B, C of the printing roller 4 and of the anilox roller 3 can be reversed in comparison with the printing operation. The cleaning process starts by removing the ink from the blade chamber 2. Subsequently the blade chamber 2 is filled with solvent via the feed line 9. In order to enable the solvent to take up as much of printing ink as possible from the anilox roller, the solvent is circulated by constantly removing it from the blade chamber 2 via the discharge line 10 and feeding this and/or new solvent to the blade chamber 2 via the feed line 9. If the rotation of the print roller 4 is stopped all areas of the printing plate 8 come into contact with the anilox roller 3 within one rotation whereby the printing plate 8 releases a part of the printing ink clinging to it. In order to ensure a good ink transfer, the anilox roller 3 can be arranged closer to the print roller 4 as can be seen in FIG. 2. Due to the earlier flow of the saucers through the blade chamber 2, the latter are completely or partly filled with solvent, thus further improving the ink transfer. The saucers of the anilox roller 3 that are supplied with printing ink are cleaned by the circulation of new solvent inside the blade chamber 2. The cleaning operation of the inking unit 1 is maintained till there is no more printing ink on the printing plate 8.

| | List of reference symbols |
|---|---|
| 1 | Inking unit |
| 2 | Blade chamber |
| 3 | Anilox roller |
| 4 | Print roller |
| 5 | Printing substrate |
| 6 | Impression cylinder |
| 7 | Deflecting roller |
| 8 | Printing plate |
| 9 | Feed line |
| 10 | Discharge line |
| A | Rotational direction of the impression cylinder |
| B | Rotational direction of the printing roller |
| C | Rotating direction of the anilox cylinder |

1. Process for the cleaning of components (8) of rollers that are involved in the printing process. The cleaning process involves supplying solvents to these rollers that remain in the printing machine while being cleaned. The process in accordance with the present invention is characterized by the fact that
the printing ink is removed from the blade chamber (2) and the blade chamber (2) is filled with solvent and
that during the cleaning an active connection is maintained between the blade chamber (2) and the uncleaned components (8) of the rollers (3, 4) that are involved in the printing process. This active connection does not interfere with the transfer of the solvent. The process in accordance with the invention is also characterized by the fact that
the rollers (3, 4) rotate during the cleaning process
so that solvent is transferred from the blade chamber (2) onto the uncleaned components of the rollers (3, 4) that are involved in the printing process. When the solvent arrives on the components to be cleaned, ink is diluted and/or dried residual ink is dissolved and transported back to the blade chamber by the rotation of the rollers (3, 4).

2. Process in accordance with claim 1 characterized by the fact that components (8) of several rollers (3, 4) are cleaned, whereby first the roller (3) that is in direct contact with the blade chamber is cleaned, while the active connection with this or the other rollers (4) is interrupted and then the active connection between each cleaned roller (3) and the next adjoining roller (4) is reestablished successively.

3. Process in accordance with claim 1 characterized by the fact that the solvent is continuously circulated inside the blade chamber (2).

4. Process in accordance with claim 3 characterized by the fact that a part of the solvent is sucked off via a discharge line (9) from the blade chamber (2) and that a part of the discharged and/or non-contaminated solvent is fed to the blade chamber (2) via a feed line (10).

5. Process in accordance with claim 1 characterized by the fact that the roller (3) that is in direct connection with the blade chamber (2) is maintained in constant rotation for its cleaning and in constant contact with the solvent contained in the blade chamber (2).

6. Process in accordance with claim 1 characterized by the fact that the rollers (3, 4) between which an active connection exists, rotate with the same circumferential speeds.

7. Process in accordance with claim 1 characterized by the fact that in the cleaning operation the rollers (3, 4) between which an active connection exists, are arranged closer to each other in comparison to their arrangement in the printing operation.

8. Process in accordance with claim 1 characterized by the fact that the rotational direction of the rollers (3, 4) is reversed at least once.

9. Control equipment for a printing machine for the automatic implementation of a process in accordance with claim 1.
